(19) United States
(12) Patent Application Publication
(10) Pub. No.: US 2026/0219056 A1
(43) Pub. Date: Jul. 30, 2026

(54) INFORMATION PROCESSING DEVICE, INFORMATION PROCESSING METHOD, AND RECORDING MEDIUM

(71) Applicant: NEC Corporation, Tokyo (JP)

(72) Inventors: Shinji FUNAI, Tokyo (JP); Takahiro MATSUI, Tokyo (JP); Yoshiya UOTANI, Tokyo (JP); Tomoki ISHII, Tokyo (JP)

(73) Assignee: NEC Corporation, Tokyo (JP)

(21) Appl. No.: 19/146,256

(22) PCT Filed: Mar. 24, 2023
(86) PCT No.: PCT/JP2023/011715

§ 371 Date: Jul. 8, 2025

(51) Int. Cl. G01C 21/34; G01C 21/36

(52) U.S. Cl. CPC G01C 21/3476; G01C 21/3484; G01C 21/367

(57) ABSTRACT

An information processing device according to the present invention includes: one or more memories storing instructions; and one or more processors configured to execute the instructions to: acquire an image of a road in the traveling direction from the current position of a moving body; acquire information pertaining to a travelable area of the road which is determined in accordance with a type of the moving body; and display at least one of the travelable area or an untravelable area in the image.

### TECHNICAL FIELD

The present disclosure relates to an information processing device, an information processing method, and a recording medium.

### BACKGROUND ART

Various visual information is provided via a display or navigation mounted on a vehicle to assist traveling of the vehicle and other transportation means. For example, PTL 1 discloses indicating a boundary line between a vehicle road on which the vehicle is currently traveling and an entry prohibition area of the vehicle.

### CITATION LIST

### Patent Literature

PTL 1: JP 2020-064047 A

### SUMMARY OF INVENTION

### Technical Problem

However, the light vehicle such as the electric scooter has a place where the light vehicle can travel and a place where the light vehicle cannot travel on the road, which is difficult for the user who rents the light vehicle to understand.

An example of an object of the present disclosure is to provide an information processing device capable of indicating a travelable place in a manner the user can easily understand.

### Solution to Problem

An information processing device according to one aspect of the present disclosure includes: an image acquisition means for acquiring an image of a road in an advancing direction from a current position of a moving body, an information acquisition means for acquiring information pertaining to a travelable area of the road defined by a type of the moving body, and a display means for displaying at least one of the travelable area and an untravelable area in the image.

An information processing method according to one aspect of the present disclosure in which a computer performs acquiring an image of a road in an advancing direction from a current position of a moving body, acquiring information pertaining to a travelable area of the road defined by a type of the moving body, and displaying at least one of the travelable area and an untravelable area in the image.

A recording medium according to one aspect of the present disclosure storing a program for causing a computer to execute processes of acquiring an image of a road in an advancing direction from a current position of a moving body, acquiring information pertaining to a travelable area of the road defined by a type of the moving body, and displaying at least one of the travelable area and an untravelable area in the image.

### Advantageous Effects of Invention

According to the present disclosure, an information processing device capable of indicating a travelable place in a manner the user can easily understand can be provided.

### BRIEF DESCRIPTION OF DRAWINGS

FIG. 1 is a block diagram illustrating an information processing device according to a first example embodiment.

FIG. 2 is a diagram illustrating a hardware configuration in which the information processing device according to the first example embodiment is achieved by a computer device and its peripheral device.

FIG. 3 is a display example of a travelable area in the first example embodiment.

FIG. 4 is a flowchart illustrating an operation of the information processing device according to the first example embodiment.

FIG. 5 is a block diagram illustrating an information processing device according to a modified example of the first example embodiment.

FIG. 6 is a display example of a traveling condition in a modified example of the first example embodiment.

FIG. 7 is a flowchart illustrating an operation of the information processing device in a modified example of the first example embodiment.

FIG. 8 is a block diagram illustrating an information processing device according to a modified example of the first example embodiment.

FIG. 9 is a display example of a travel recommendation area in another modified example of the first example embodiment.

FIG. 10 is a flowchart illustrating an operation of an information processing device in another modified example of the first example embodiment.

FIG. 11 is a block diagram illustrating an information processing device according to a second example embodiment.

FIG. 12 is a display example of a travelable route in the second example embodiment.

FIG. 13 is a flowchart illustrating an operation of the information processing device according to the second example embodiment.

### EXAMPLE EMBODIMENT

Hereinafter, example embodiments of an information processing device, an information processing method, and a non-transitory recording medium recording a program according to the present disclosure will be described in detail with reference to the drawings. The present example embodiments are not intended to limit the disclosed technology.

### First Example Embodiment

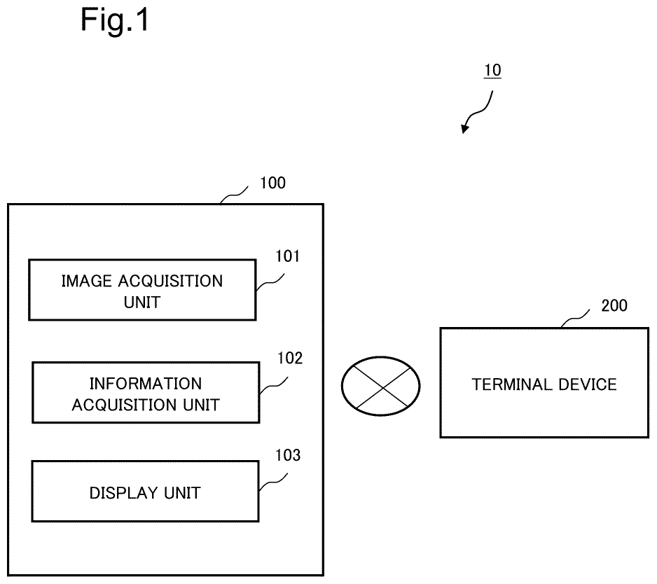

FIG. 1 is a block diagram illustrating an information processing device 100 according to the present example embodiment. An information processing system 10 is a system for allowing a user who has rented a moving body to grasp a travelable area according to a type of the moving body. The information processing system 10 includes an information processing device 100 and a terminal device 200. As illustrated in FIG. 1, the information processing device 100 includes an image acquisition unit 101, an information acquisition unit 102, and a display unit 103.

The terminal device 200 is connected to the information processing device 100 via a network. The terminal device 200 is a terminal carried by a user or a terminal provided on a moving body. In the present example embodiment, it is assumed that an application program of a navigation system for displaying a place where a moving body is currently traveling on a map is installed in the terminal device 200. Furthermore, the information processing system 10 according to the present example embodiment cooperates with a rental service for moving bodies, and can acquire information on a travelable area on a road according to the type of the rental moving body when the user uses the rental moving body. The travelable area is a travelable area on a road determined by a regulation according to a type of a moving body. The type of the moving body indicates, for example, a classification of the moving body such as a motorized bicycle, a small special automobile, or a light vehicle.

A storage device 505 of the information processing device 100 stores map data. The map data includes road information. The road information includes information such as a width of a road at a position on the map and information pertaining to a travelable area and a traveling condition of each moving body. The traveling condition includes a speed limit of each moving body or a traveling rule unique to the moving body such as a crossing method or a right turn method of a pedestrian crossing. The traveling condition may be information acquired from a type of a sign provided on the road. In addition, the travelable area and the traveling condition may be information set based on the width of the road and the regulation information of each moving body. In this regulation information, for example, it is assumed that whether travelable or a speed limit based on a width of a roadway or a sidewalk is defined. In the case of a rental moving body, the information may be set based on regulation information established by a rental dealer. In addition, in the case of a rental moving body, information pertaining to a return port indicating the place of the return port and the availability is included as the map data. The information of the return port includes information of the size of each return port and a store provided in the return port.

The moving body is a vehicle excluding an automobile defined in the Road Traffic Law, and includes a light vehicle and a motorized bicycle. The moving body includes a bicycle, a bicycle with an electric motor, a motorcycle, an electric scooter, an electric wheelchair, and the like, and is not limited to a specific moving body.

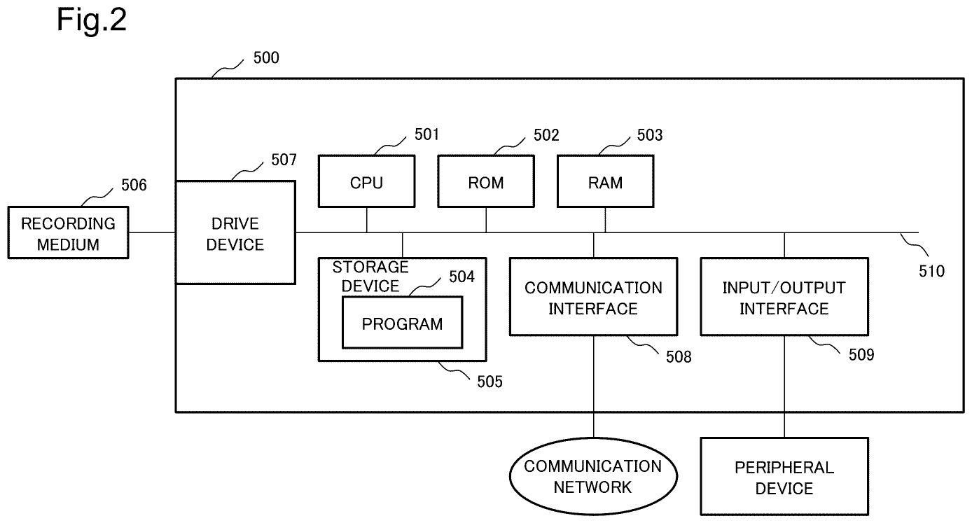

FIG. 2 is a diagram illustrating an example of a hardware configuration in which the information processing device 100 according to the first example embodiment of the present disclosure is achieved by a computer device 500 including a processor. As illustrated in FIG. 2, the information processing device 100 includes a central processing unit (CPU) 501, a memory such as a read only memory (ROM) 502 and a random access memory (RAM) 503, a storage device 505 such as a hard disk that stores a program 504, a communication interface 508 for network connection, and an input/output interface 509 that inputs and outputs data. In the first example embodiment, the information processing device 100 is connected to each component via a bus 510.

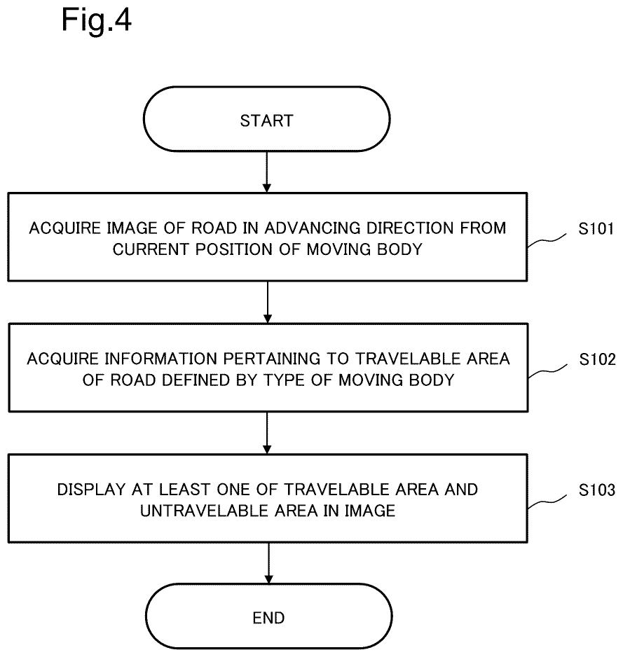

The CPU 501 operates an operating system to control the entire information processing device 100 according to the first example embodiment of the present invention. In addition, the CPU 501 reads programs and data from a recording medium 506 mounted on, for example, a drive device 507 or the like into the memory. Furthermore, the CPU 501 functions as the image acquisition unit 101, the information acquisition unit 102, the display unit 103, and a part thereof in the first example embodiment, and executes a process or a command in a flowchart illustrated in FIG. 4 to be described later based on a program.

Examples of the recording medium 506 include, for example, an optical disc, a flexible disk, a magnetic optical disc, an external hard disk, or a semiconductor memory. A semiconductor memory or the like, which is a part of the recording medium, is a non-volatile storage device and records a program therein. Furthermore, the program may be downloaded from an external computer (not illustrated) connected to a communication network.

As described above, the first example embodiment illustrated in FIG. 1 is achieved by the computer hardware illustrated in FIG. 2. However, the means for achieving each unit included in the information processing device 100 of FIG. 1 is not limited to the configuration described above. The information processing device 100 may be achieved by one physically coupled device, or may be achieved by a system including a plurality of devices obtained by connecting two or more physically separated devices in a wired or wireless manner.

The image acquisition unit 101 is a means for acquiring an image of a road in an advancing direction from the current position of the moving body. In the present example embodiment, the moving body is provided with a photographing device such as a camera for photographing the advancing direction, and the image acquisition unit 101 acquires, for example, a moving image of a road photographed in real time by the photographing device.

Furthermore, the image acquisition unit 101 may specify the current position and the application by a known method based on, for example, information obtained from a global positioning system (GPS) mounted on the moving body or the terminal device 200 and an orientation sensor such as a gyro sensor or an acceleration sensor, and acquire a street view image of a map application obtained by photographing the advancing direction from the specified point or an image of a stereoscopic map stored in a navigation system. The image acquisition unit 101 outputs the acquired image of the road to the display unit 103.

The information acquisition unit 102 is a means for acquiring information pertaining to a travelable area of a road on an image defined by the type of the moving body. The travelable area is, for example, a traveling area of a road to be followed by each moving body determined by a law including the Road Traffic Law or a regulation such as a government ordinance, and is, for example, a division of a traveling place such as a roadway or a sidewalk, a dedicated lane of a specific moving body, or the like. The information acquisition unit 102 acquires information pertaining to a travelable area of a road from the road information associated with map data, and outputs the information to the display unit 103.

The display unit 103 is a means for displaying at least one of the travelable area and the untravelable area in the image. The display unit 103 displays at least one of the travelable area and the untravelable area in the image of the road input from the image acquisition unit 101 based on the information pertaining to the travelable area input from the information acquisition unit 102. In a case where the moving body must travel on the roadway, the display unit 103 may add an arrow to the roadway, may highlight the roadway by changing a color or a thickness of a line of the roadway, or may add “x” to the sidewalk area to indicate that traveling is prohibited. Furthermore, in a case where the moving body must travel in a specific traveling lane, the display unit 103 may add an arrow to the traveling lane or highlight the traveling lane. In addition, the display unit 103 may display that traveling is prohibited by adding “x” or the like to a traveling lane where the moving body cannot travel.

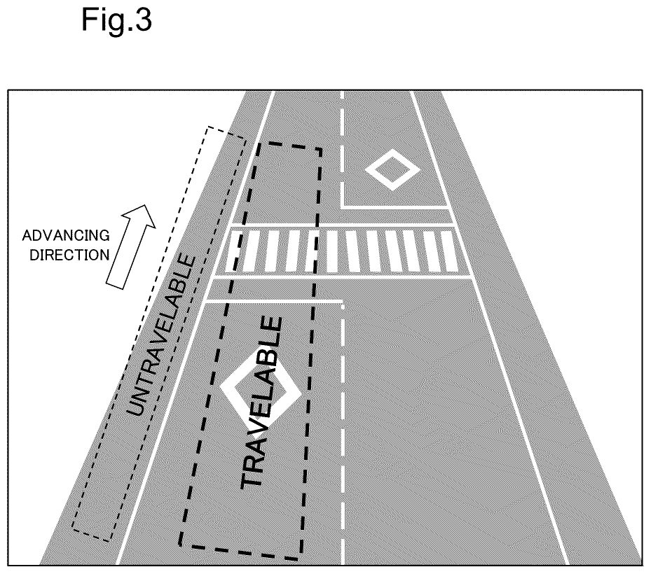

FIG. 3 is a display example of a travelable area in the first example embodiment. In the example of FIG. 3, it is indicated as travelable on a roadway on the image of the road, and indicated as not travelable on a sidewalk on the image. The display of the travelable area in the present example embodiment is not limited to the example of FIG. 3, and may be a display mode in which it can be grasped whether the moving body can travel on a roadway or a sidewalk, or which lane corresponds to the travelable lane. For example, in the display example of FIG. 3, “∘” may be added to the roadway and “x” may be added to the sidewalk instead of displaying “travelable” and “untravelable”, respectively. In addition, the display unit 103 may display only at least one of the travelable area and the untravelable area.

FIG. 4 is a flowchart illustrating an outline of an operation of the information processing device 100 according to the first example embodiment. A process according to this flowchart may be performed based on program control executed by the processor described above. The processing according to this flowchart is continuously performed, for example, while the user is traveling on the road with the moving body.

As illustrated in FIG. 4, the image acquisition unit 101 acquires an image of a road in the advancing direction from the current position of the moving body (step S101). Next, the information acquisition unit 102 acquires information pertaining to a travelable area of the road defined by the type of the moving body (step S102). Lastly, the display unit 103 displays at least one of the travelable area and the untravelable area in the image (step S103). Thus, the information processing device 100 ends the process.

In the present example embodiment, the information acquisition unit 102 acquires information pertaining to a travelable area of a road defined by a type of a moving body, and the display unit 103 displays at least one of the travelable area and the untravelable area in an image. As a result, it is possible to indicate a place where the vehicle can travel in a manner the user can easily grasp the place.

### First Modified Example of First Example Embodiment

Next, each modified example of the first example embodiment will be described. The configurations of each of the modified examples can be combined with each other, and for example, in the first modified example, a travel recommendation area may be specified from among the travelable areas, and the traveling unit 114 may cause automatic traveling through the travel recommendation region based on the traveling condition.

In the first example embodiment described above, at least one of the travelable area and the untravelable area is displayed in the image of the road in the advancing direction. In the present modified example, the traveling condition of the travelable area is further displayed in the above-described image, and automatic traveling is performed based on the traveling condition.

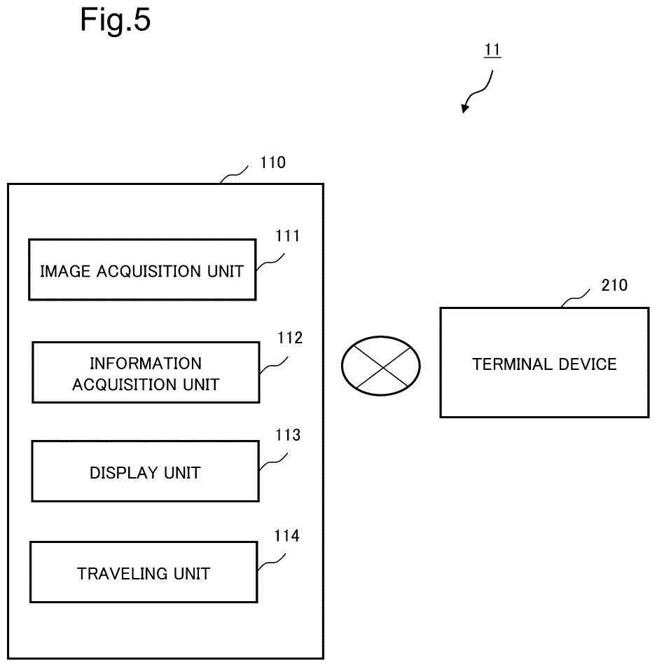

FIG. 5 is a block diagram including an information processing device according to a modified example of the first example embodiment.

As illustrated in FIG. 5, an image acquisition unit 111, an information acquisition unit 112, a display unit 113, and a traveling unit 114 are provided. In the present modified example, the configuration of the image acquisition unit 111 is similar to that of the image acquisition unit 101 in the first example embodiment.

The information acquisition unit 112 acquires, in addition to the information pertaining to the travelable area of the road, a traveling condition defined by the type of moving body of the road. The traveling condition is, for example, a condition determined by regulation information to be followed when each moving body travels on a road based on a law including the Road Traffic Law or a regulation such as a government ordinance. For example, when a shopping street or the like is a pedestrian exclusive road, the light vehicle has a regulation of getting off a moving body and moving by foot. The information acquisition unit 112 may acquire, as the traveling condition, for example, at least one of a speed limit or a traveling condition of getting on or off the vehicle. The information acquisition unit 112 acquires the traveling condition of the road included in the image from the road information.

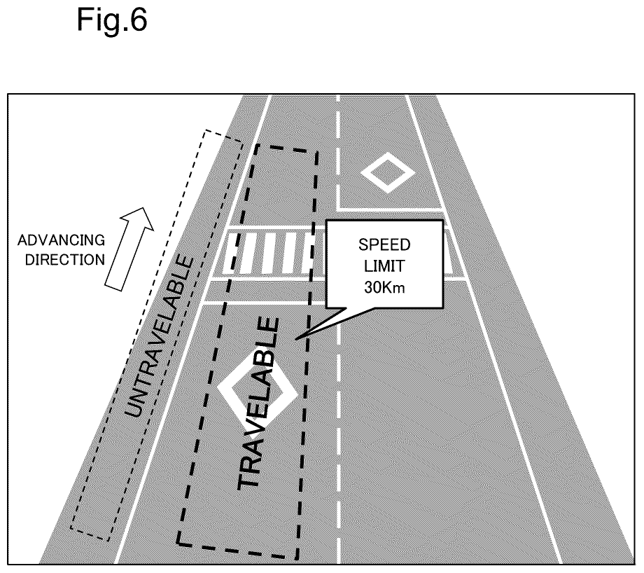

The display unit 113 displays the traveling condition of the travelable area on the image of the road. FIG. 6 is a display example of a traveling condition in a modified example of the first example embodiment. In the example of FIG. 6, it is illustrated that the travelable area has a speed limit of 30 km/hour.

The traveling unit 114 is a means that causes automatic traveling through the travelable area based on the traveling condition. The traveling unit 114 causes the moving body to automatically travel by a known method. The traveling unit 114 acquires position information of the moving body by, for example, a GPS mounted on the moving body. Then, the traveling unit 114 controls an operation means such as an accelerator, a brake, or a steering wheel provided in the moving body based on the traveling condition associated with the position information. For example, when the speed limit of the road on which the moving body is traveling is 30 km/hour, the traveling unit 114 controls the accelerator or the brake to travel in such a way as not to exceed the speed limit. In addition, when a traveling route to a destination is set in the navigation system, the traveling unit 114 may control the operation means of the moving body in such a way as to automatically travel the travelable area on the traveling route.

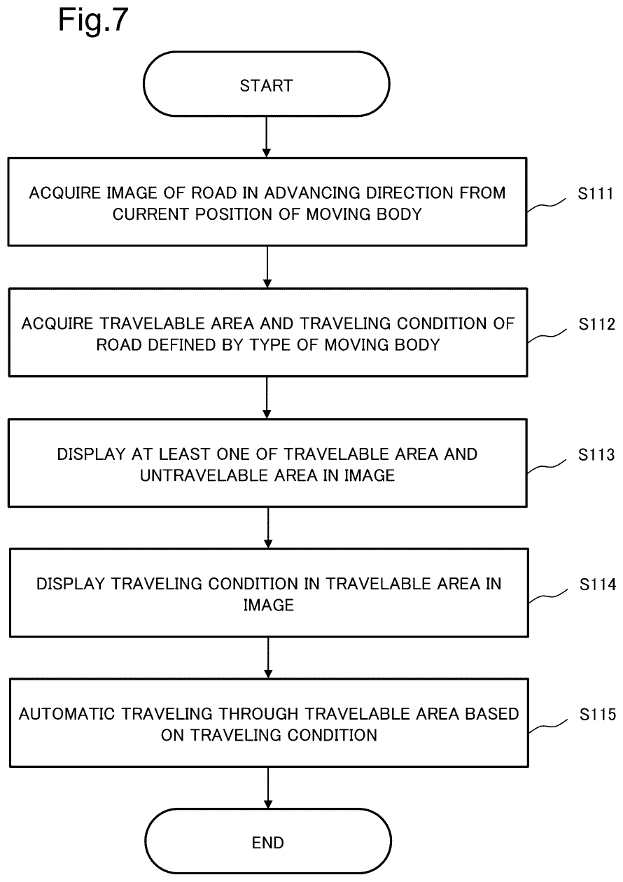

FIG. 7 is a flowchart illustrating an outline of an operation of the information processing device 110 in a modified example of the first example embodiment. A process according to this flowchart may be performed based on program control executed by the processor described above.

As illustrated in FIG. 7, the image acquisition unit 111 acquires an image of a road in the advancing direction from the current position of the moving body (step S111). Next, the information acquisition unit 112 acquires a travelable area and a traveling condition of the travelable area of the road defined by the type of the moving body (step S112). Then, the display unit 113 displays at least one of the travelable area and the untravelable area in the image (step S113). In addition, the display unit 113 displays the traveling condition of the travelable area in the image (step S114). The traveling unit 114 causes automatic traveling through the travelable area based on the traveling condition (step S115). Thus, the information processing device 110 ends the process.

In the present modified example, the display unit 113 displays the traveling condition of the travelable area in the image of the road. Therefore, the user can grasp the traveling condition of the travelable area. In addition, the traveling unit 114 causes automatic traveling through the travelable area based on the traveling condition. Therefore, the user can travel without worrying about the traveling conditions.

### Second Modified Example of First Example Embodiment

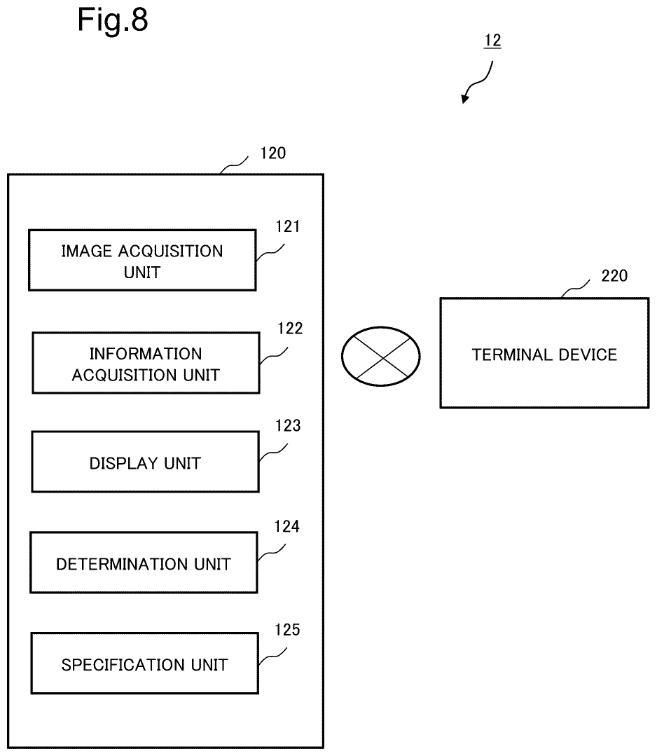

Next, another modified example of the first example embodiment will be described with reference to the drawings. FIG. 8 is a block diagram including an information processing device according to another modified example of the first example embodiment. As illustrated in FIG. 8, an image acquisition unit 121, an information acquisition unit 122, a display unit 123, a determination unit 124, and a specification unit 125 are provided. The image acquisition unit 121 and the information acquisition unit 122 have the same configurations as the image acquisition unit 101 and the information acquisition unit 102 in the first example embodiment.

In the present modified example, for example, when a plurality of travelable areas exist, not only the travelable area of the moving body is displayed, but also an area where the moving body easily travels in the travelable area is displayed. In the present modified example, for example, a case where a moving body can travel on both a roadway and a sidewalk or a case where a plurality of travelable lanes exist is assumed.

The determination unit 124 is a means for determining the road surface condition of the travelable area. For example, the determination unit 124 detects deterioration of a road such as unevenness of a road surface in the travelable area or an untravelable area such as a puddle based on an image obtained by photographing a road in the travelable area. Then, when the size of the non-travelable area or the non-travelable degree does not exceed a predetermined reference, the determination unit 124 determines that the road surface condition is good. Then, when the size of the non-travelable area or the non-travelable degree does not exceed a predetermined reference, the determination unit 124 determines that the road surface condition is good. The determination unit 124 may detect the non-travelable area by a known method based on sensor information acquired in the past by an image sensor, an accelerometer, or the like mounted on another moving body. In this case, it is assumed that sensor information of an image sensor, an accelerometer, or the like mounted on another moving body is stored in the storage device 505 in association with the map data. When determining that the road surface condition is good, the determination unit 124 outputs information on the size and the number of detected non-travelable areas to the specification unit 125.

The specification unit 125 is a means for specifying the travel recommendation area from the travelable area when the road surface condition of the travelable area is good. For example, the specification unit 125 specifies a travelable area having lesser non-travelable areas as a travel recommendation area. Specifically, in a case where the moving body can travel on both the roadway and the sidewalk, the specification unit 125 specifies either the roadway or the sidewalk. Furthermore, in a case where there are a plurality of lanes on which the moving body can travel, the specification unit 125 specifies one of the lanes.

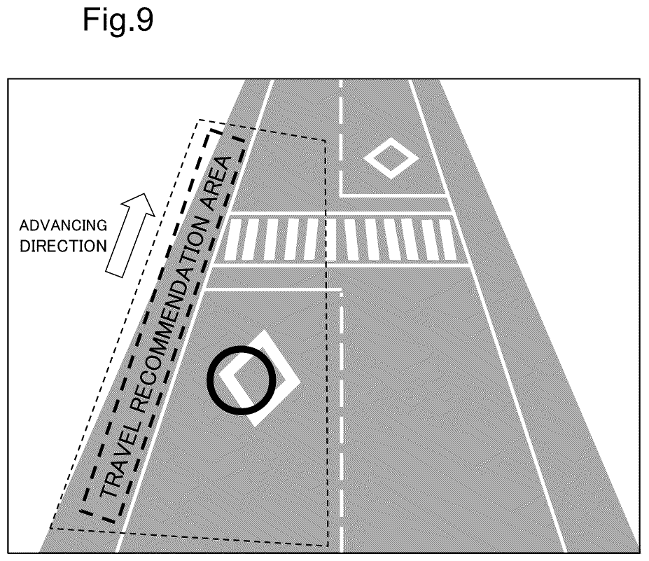

The display unit 123 displays the travel recommendation area on the image. FIG. 9 is a display example of a travel recommendation area in another modified example of the first example embodiment. In the example of FIG. 9, both the roadway and the sidewalk are indicated by “∘” as the travelable area, and the sidewalk is specified as the travel recommendation area among the travelable areas. When the determination unit 124 determines that the road surface condition is not good, the display unit 123 may display guidance information to a return port or a store within a predetermined distance from the current position. The guidance information may include information indicating the position of the return port or the store.

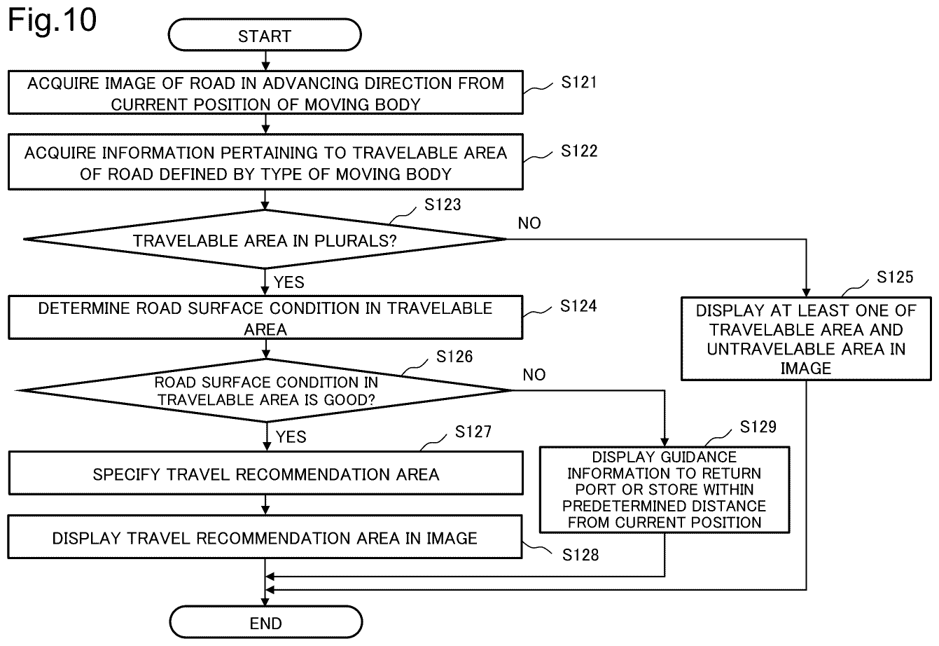

FIG. 10 is a flowchart illustrating an outline of an operation of an information processing device 120 according to a modified example of the first example embodiment. A process according to this flowchart may be performed based on program control executed by the processor described above.

As illustrated in FIG. 10, the image acquisition unit 121 acquires an image of a road in the advancing direction from the current position of the moving body (step S121). Next, the information acquisition unit 122 acquires information pertaining to a travelable area of the road defined by the type of the moving body (step S122). In a case where there are a plurality of travelable areas (step S123; YES), the determination unit 124 determines the road surface condition of the travelable area (step S124). On the other hand, in a case where there are not a plurality of travelable areas (step S123; NO), the display unit 123 displays at least one of the travelable area and the untravelable area in the image (step S125).

Next, when determined that the road surface condition of the travelable area is good by the determination unit 124 (S126; YES), a travel recommendation area is specified (step S127). Then, the display unit 123 displays the travel recommendation area in the image (step S128). On the other hand, when determined that the road surface condition in the travelable area is not good by the specification unit 125 (step S126; NO), the display unit 123 displays guidance information to the return port or the store within a predetermined distance from the current position (step S129). Thus, the information processing device 120 ends the process.

In the present modified example, when determined that the road surface condition of the travelable area is good, the specification unit 125 specifies the travel recommendation area from the travelable area, and the display unit 123 displays the travel recommendation area. As a result, it is possible to indicate a traveling area where the user can easily travel. Furthermore, when determined that the road surface condition of the travelable area is not good, the display unit 123 displays guidance information to a return port or a store within a predetermined distance from the current position. As a result, in a case of a road surface condition where it is difficult for the moving body to travel, it is possible to encourage the user to return the moving body or take a break.

### Second Example Embodiment

Next, a second example embodiment of the present disclosure will be described in detail with reference to the drawings. Hereinafter, description of contents overlapping with the above description will be omitted to the extent that the description of the present example embodiment is not unclear.

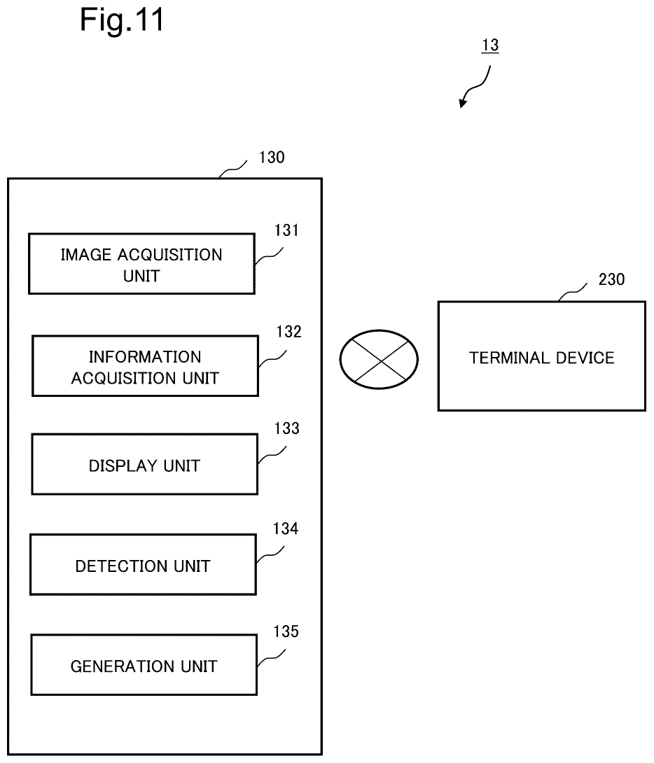

FIG. 11 is a block diagram including an information processing device 130 according to the second example embodiment. Similarly to the computer device illustrated in FIG. 2, the functions of the information processing device 130 can be achieved not only by hardware but also by a computer device or software based on program control.

Referring to FIG. 11, the information processing device 130 includes an image acquisition unit 131, an information acquisition unit 132, a display unit 133, a detection unit 134, and a generation unit 135. The image acquisition unit 131 and the information acquisition unit 132 have the same configurations as the image acquisition unit 101 and the information acquisition unit 102 in the first example embodiment.

In the present example embodiment, for example, a travelable route to a specific place included in the image is generated. Furthermore, in the present modified example, the specific place is, for example, a store where the user stops by, and in particular, a store where the product the user is planning to purchase is in stock.

In the present example embodiment, the map data stored in the storage device 505 includes store information. The store information is information pertaining to a store existing at a position on a map, and includes, for example, inventory information of a product sold in the store, information of a recommended product of the store or a coupon distributed in the store. Furthermore, in the present example embodiment, the input of the shopping list information of the user may be accepted by an application program or a navigation system for using the rental of the moving body. The shopping list information is a list of product information the user is planning to purchase, and is stored in the storage device 505 in association with identification information of the user such as a user ID.

The detection unit 134 is a means for detecting, on the image, a store having a stock of a product the user is planning to purchase. For example, the detection unit 134 extracts, in advance, a store having a stock of products planned to be purchased from among the stores near the travel route to the destination. Then, when the moving body approaches within a predetermined distance from the extracted store, the detection unit 134 detects the store included in the image. The predetermined distance is, for example, a distance at which a store appears in an image obtained by photographing the advancing direction from the current position.

When the detection unit 134 detects a store on the image, the generation unit 135 generates a travelable route from the current position of the moving body to the store. The generation unit 135 generates a travelable route for traveling in a travelable area of the road to the store according to the traveling conditions. The travelable route may include at least one of crossing at a pedestrian crossing or making a right turn at an intersection. In the present example embodiment, it is assumed that the detected store is at a place of turning right at an intersection in the advancing direction when viewed from the current position of the moving body. A moving body such as an electric scooter has a unique traveling condition when crossing a pedestrian crossing and making a right turn at an intersection. In the present example embodiment, when crossing a pedestrian crossing, it is necessary to get off a moving body and walk while pushing the moving body, and when making a right turn at an intersection, two-step right turn and small turn right turn are prohibited. In addition, there is a traveling condition that when traveling on a roadway, the user does not need to get off the moving body, but when traveling on a sidewalk, the user needs to get off the moving body.

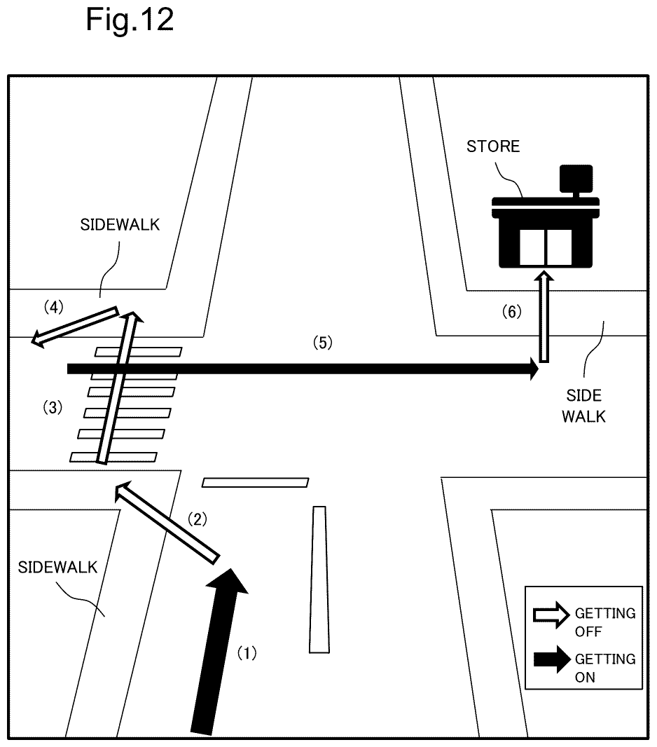

The display unit 133 displays the generated travelable route. FIG. 12 is a display example of a travelable route in the second example embodiment. In the example of FIG. 12, a location of getting off the vehicle and advancing and a location of getting on the vehicle and advancing are indicated by different arrows in the travelable route. Specifically, first, (1) Get on the vehicle and advance from the current position of the moving body to the front of the stop line. (2) Get off the vehicle in front of the stop line and enter the sidewalk. (3) Get off the vehicle and cross the pedestrian crossing. (4) Go from the sidewalk to the roadway while getting off. (5) Get on the vehicle and cross the intersection. (6) Get off the vehicle when crossing the sidewalk in front of the store and enter the store. The display of the travelable route in the present example embodiment is not limited to the example of FIG. 12, and may be any display mode as long as it is possible to grasp the travelable route of the moving body and whether traveling in getting on or getting off.

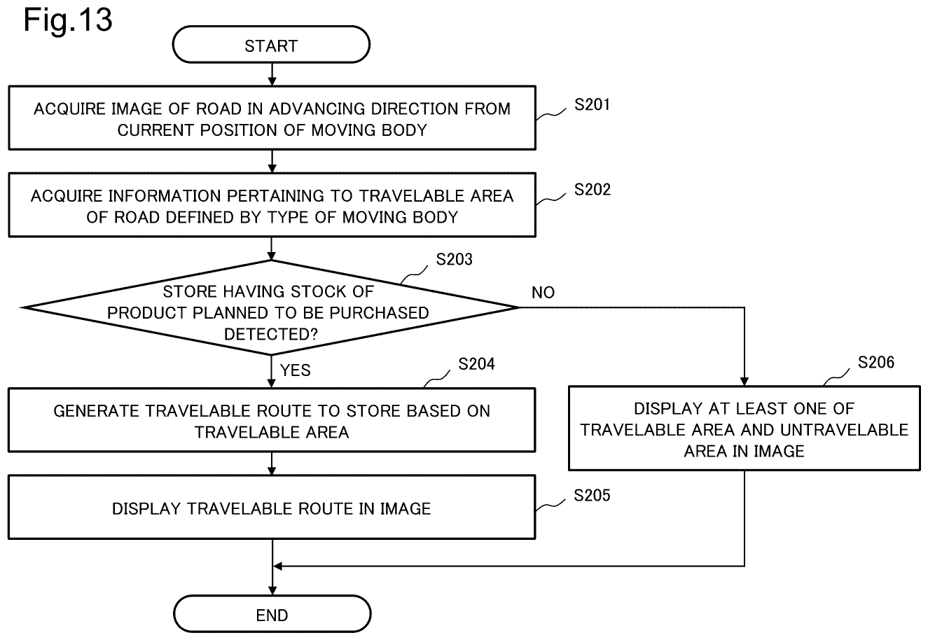

FIG. 13 is a flowchart illustrating an outline of an operation of an information processing device 130 according to a modified example of the second example embodiment. A process according to this flowchart may be performed based on program control executed by the processor described above.

As illustrated in FIG. 13, the image acquisition unit 131 acquires an image of a road in the advancing direction from the current position of the moving body (step S201). Next, the information acquisition unit 132 acquires information pertaining to a travelable area of the road defined by the type of the moving body (step S202). In a case where the detection unit 134 detects a store having a stock of the product planned to be purchased (S203; YES), the generation unit 135 generates a travelable route to the store based on the travelable area (step S204), and the display unit 133 displays the travelable route in the image (step S205). On the other hand, in a case where the detection unit 134 does not detect a store having a stock of the product planned to be purchased (S203; NO), the display unit 133 displays at least one of the travelable area and the untravelable area in the image (step S206). Thus, the information processing device 130 ends the process.

In the present example embodiment, when the detection unit 134 detects a store having a stock of the product planned to be purchased, the generation unit 135 generates a travelable route to the store, and the display unit 133 displays the travelable route. As a result, for example, even in a case where a store having a stock of the product planned to be purchased is located at a location of turning right at an intersection of a main street, or the like, and it is difficult to grasp how to reach the place by a moving body, it is possible to indicate to the user a route on which the moving body should travel.

While the present disclosure has been particularly shown and described with reference to each of example embodiments, the present disclosure is not limited to the above example embodiments. The configurations and details of the present disclosure may include example embodiments to which various changes that can be grasped by those of ordinary skill in the art without departing from the scope of the present disclosure are applied. The present disclosure may include example embodiments in which the matters described in the present specification are appropriately combined or replaced as necessary. For example, the matters described using a specific example embodiment can be applied to other example embodiments as long as no contradiction occurs. For example, although the plurality of operations is described in order in the form of a flowchart, the order of description does not limit the order in which the plurality of operations is executed. Therefore, when each example embodiment is implemented, the order of the plurality of operations can be changed within a range that does not interfere with the content.

### REFERENCE SIGNS LIST

10, 11, 12,13 information processing system
100, 110, 120, 130 information processing device
101, 111, 121, 131 image acquisition unit
102, 112, 122, 132 information acquisition unit
103, 113, 123, 133 display unit
114 traveling unit
124 determination unit
125 specification unit
134 detection unit
135 generation unit
200, 210, 220, 230 terminal device
500 computer device
501 CPU
502 ROM
503 RAM
504 program
505 storage device
506 recording medium
507 drive device
508 communication interface
509 input/output interface
510 bus

What is claimed is:

1. An information processing device comprising:
one or more memories storing instructions; and
one or more processors configured to execute the instructions to:
acquire an image of a road in an advancing direction from a current position of a moving body;
acquire information pertaining to a travelable area of the road defined by a type of the moving body; and
display at least one of the travelable area or an untravelable area in the image.

2. The information processing device according to claim 1, wherein the one or more processors are configured to execute the instructions to:
further acquire a traveling condition of the travelable area defined by the type of a moving body of the road, and
display the traveling condition on the image.

3. The information processing device according to claim 2, wherein the one or more processors are configured to execute the instructions to:
cause the travelable area to be automatically traveled based on the traveling condition.

4. The information processing device according to claim 1, wherein the one or more processors are configured to execute the instructions to:
generate a travelable route in a case of traveling through the travelable area to a specific place included in the image; and
display the travelable route.

5. The information processing device according to claim 4, wherein the travelable route includes at least one of crossing at a pedestrian crossing or making a right turn at an intersection.

6. The information processing device according to claim 4, wherein the one or more processors are configured to execute the instructions to:
detect, on the image, a store having a stock of a product a user is planning to purchase, and wherein
generate a travelable route to the store.

7. The information processing device according to claim 1, wherein the one or more processors are configured to execute the instructions to:
determine a road surface condition of the travelable area in the image;
specify a travel recommendation area from the travelable area when the road surface condition is determined to be good; and
display the travel recommendation area in the image.

8. The information processing device according to claim 7, wherein the one or more processors are configured to execute the instructions to:
display guidance information to a return port or a store within a predetermined distance from a current position in a case where the road surface condition is not determined to be good.

9. An information processing method in which a computer performs:
acquiring an image of a road in an advancing direction from a current position of a moving body;
acquiring information pertaining to a travelable area of the road defined by a type of the moving body; and
displaying at least one of the travelable area or an untravelable area in the image.

10. A non-transitory recording medium storing a program for causing a computer to execute processes of:
acquiring an image of a road in an advancing direction from a current position of a moving body;
acquiring information pertaining to a travelable area of the road defined by a type of the moving body; and
displaying at least one of the travelable area or an untravelable area in the image.
